(19) United States
(12) Patent Application Publication
(10) Pub. No.: US 2010/0135580 A1
(43) Pub. Date: Jun. 3, 2010

(54) METHOD FOR ADJUSTING VIDEO FRAME

(75) Inventor: Hong-Bo LIU, NANJING (CN)

Correspondence Address: BRIAN M. MCINNIS, 12th Floor, Ruttonjee House, 11 Duddell Street, Hong Kong, HK

(73) Assignee: INVENTEC APPLIANCES CORP., TAIPEI HSIEN (TW)

(21) Appl. No.: 12/325,136

(22) Filed: Nov. 28, 2008

(51) Int. Cl. G06K 9/46

(52) U.S. Cl. 382/195

(57) ABSTRACT

A method for adjusting a face area of a user in the video frame captured by a camera lens is disclosed. In the method, an edge of an image in the video frame is detected, wherein the image contains a face area representing a face of a user. Then, a plurality of facial features of the face are extracted from the face area according to the image edge. Then, a facial feature database is referred to for the facial features to estimate a tilt angle between a plane corresponding to the face of the user and a focusing direction of the camera lens towards the face on capturing the video frame. Finally, the estimated tilt angle is used for adjusting relative proportion between image parts in the face area. As a result, the video frame displaying an image effect of the face as seen by a person from a position in front of and level with the face and having no tilted image of the face is obtained.

### BACKGROUND

1. Field of Invention

The present invention relates to a method for adjusting a video frame. More particularly, the present invention relates to a method for adjusting a face area of a user in the video frame captured by a camera lens.

2. Description of Related Art

Along with the combination of communication and network technology, video communication becomes increasingly popular, and even becomes a new current in communication. Users may easily transfer video images to a called party by using a webcam with a camera lens when communicating. In this way, users may not only hear the voice but also see the images of the called party in is real time. Because of so, it becomes more convenient for modern humans to communicate with family and friends far away. In spite of processing video communication by computers with the webcam, more and more mobile communication product manufacturers view video communication as a requirement when designing products in order to increase competitiveness.

FIG. 1 illustrates the position of a camera lens and a user in video communication. FIG. 1 uses a mobile phone 120 to process video communication. In the design of mobile communication products, the camera lens 130 of the webcam is fixed above a monitor 140, and a user 110 is used to seeing the monitor 140 at eye level to perform video communication. That is, a face plane 150 formed by two mutually perpendicular lines, wherein the two lines are the ground line and the line crosses the nose peak of the user, forms a tilt angle θ with the camera lens 130. So, when the user 110 sees the monitor 140 and communicates, the user image captured by the camera lens 130 is not an image displaying a video image effect of the face area as seen by a person from a position in front of and substantially level with the face, but is a video frame 200 with disproportionate facial ratio as shown in FIG. 2. That is, the face area of the user adjacent to the camera lens 130 is too big, and the part far away from the camera lens 130 is too small.

In current video communication technology, the video frames are directly transferred to the called party after the camera lens of the webcam captures the video frame. That is, the video frame with the tilt angle is directly transferred without any adjustment. Thus, the called party receives the video frame with disproportionate facial ratio frequently and cannot clearly see the images of the user, and then the quality of video communication is negatively impacted.

### SUMMARY

The invention provides a method for adjusting a face area of a user in a video frame captured by a camera lens. According to a tilt angle between a plane corresponding to a face of the user and a focusing direction of the camera lens towards the face on capturing the video frame, a face area in the video frame is adjusted to obtain a video frame displaying a video image effect of the face area in it as seen by a person from a position in front of and substantially level with the face and having no tilted image of the face area.

The method is used for adjusting a face area of a user in a video frame captured by a camera lens. In the present method, an edge of an image in the video frame is detected first, wherein the image contains a face area representing a face of the user. Then, a plurality of facial features of the face of the user are extracted from the face area according to the image edge. Then, a facial feature database, which contains statistics of facial-feature data, is referred to for the facial features, to estimate a tilt angle between a plane corresponding to the face of the user and a focusing direction of the camera lens towards the face on capturing the video frame. Finally, the estimated tilt angle is used for adjusting relative proportion between image parts in the face area.

In one embodiment of the present invention, detecting the edge of the image is by an edge detection method. The image edge includes an outline of the face or an outline of one of the facial features of the user.

In one embodiment of the present invention, extracting the facial features of the user according to the image edge includes calculating a plurality of curves approximating to the image edge by a curve fitting method and extracting the facial features of the user according to the relevance between the curves, wherein extracting the facial features of the user includes determining the positions of the facial features of the face of the user according to the curves.

In one embodiment of the present invention, the facial features of the face of the user include eyes and a nose of the user. Referring to a facial feature database for the facial features of the user includes calculating a horizontal distance between the eyes and the nose of the user and comparing the horizontal distance and the facial-feature data contained by the facial feature database to estimate the tilt angle. Alternatively, a perpendicular distance between the eyes and the nose of the user may be calculated in this step, and the perpendicular distance and the facial-feature data contained by the facial feature database are compared to estimate the tilt angle.

In one embodiment of the present invention, adjusting relative proportion between image parts in the face area according to the estimated tilt angle includes scaling an appearance of the face area linearly according to the estimated tilt angle to arrive at a normal ratio in appearance of the face area to the video frame, wherein the normal ratio corresponds to an event that the tilt angle is substantially 90 degrees.

In one embodiment of the present invention, adjusting relative proportion between image parts in the face area according to the estimated tilt angle includes acquiring colors of a plurality of adjacent pixels to each pixel of the face area of the user, calculating a corrective color for said each pixel of the face area of the user according to the colors of the adjacent pixels by a two-dimension linear interpolation method, and updating an appearance of the face area with the corrective color for said each pixel of the face area of the user. The adjacent pixels include an upper left pixel, a lower left pixel, an upper right pixel and a lower right pixel adjacent to said each pixel of the face area of the user.

In one embodiment of the present invention, an offset distance between the face area and a center of the video frame is detected, and the position of the face area is changed to be at the center of the video frame according to the offset distance.

In the present invention, the position of the facial features of a face area of a user in a video frame captured by a camera lens are extracted, and a facial feature database are referred to for the facial features of the user to estimate a tilt angle between a plane corresponding to the face of the user and a focusing direction of the camera lens towards the face on capturing the video frame. The estimated tilt angle is used for adjusting relative proportion between image parts in the face area. As a result, the video frame displaying a video image effect of the face area in it as seen by a person from a position in front of and substantially level with the face and having no tilted image of the face area is obtained.

These and other features, aspects, and advantages of the present invention will become better understood with reference to the following examples and appended drawings, and provide further explanation of the invention as claimed.

### BRIEF DESCRIPTION OF THE DRAWINGS

The invention may be more fully understood by reading the following detailed description of the embodiment, with reference made to the accompanying drawings as follows:

FIG. 1 illustrates the position of the camera lens and a user in video communication.

FIG. 2 illustrates a video frame extracted by prior art in video communication.

FIG. 3 illustrates a method for adjusting a video frame according to one embodiment of this invention.

FIG. 4 illustrates a video frame before adjusting according to one embodiment of this invention.

FIG. 5 illustrates a video frame before adjusting according to another embodiment of this invention.

FIG. 6 illustrates a video frame after adjusting according to one embodiment of this invention.

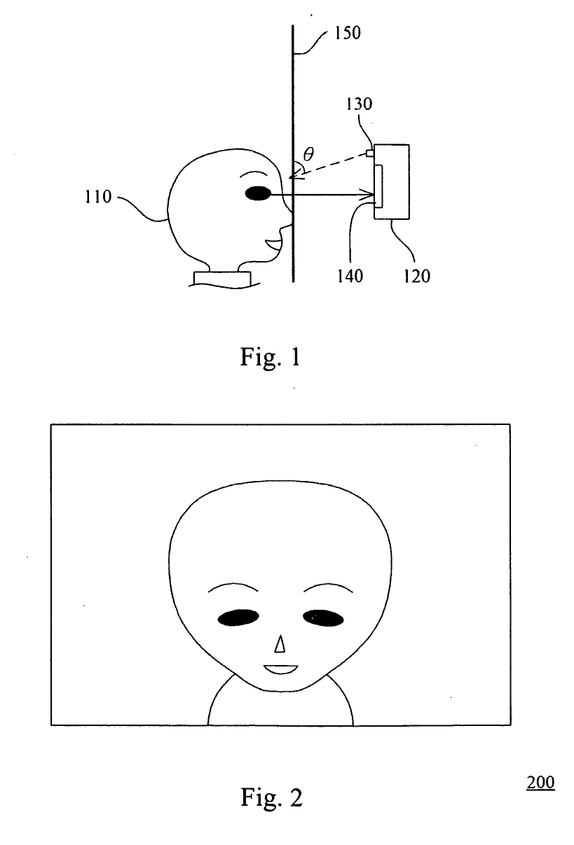

### DETAILED DESCRIPTION

A video frame which is clear to see, displaying a video image effect of an object in it as seen by a person from a position in front of and substantially level with the object, and having no image tilt of the object is quite important for those who use video communication frequently. Thus, the present invention is a method for adjusting a face area of a user in a video frame captured by a camera lens to increase the quality of video communication. It is to be understood that the following disclosure provides a plurality of embodiments to further clarify the present invention.

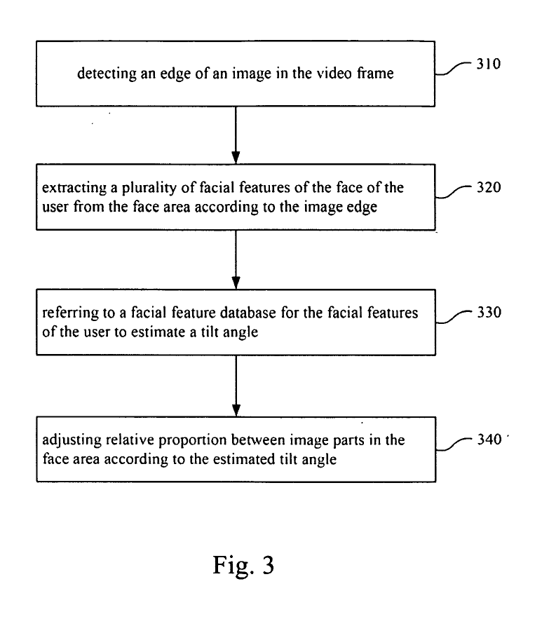

FIG. 3 illustrates a flowchart of the method for adjusting according to one embodiment of this invention. The present embodiment uses a mobile phone for a user as an example, but not to limit the scope of the invention. That is to say, other communication devices that support video communication may apply the present invention to adjust the video frames.

FIG. 3 illustrates the camera lens above the screen of a mobile phone captures video frame including the face area of a user when performing video communication by the mobile phone. Before transferring the video frame to a called party, as shown in step 310, an image edge in the video frame is detected, wherein the image edge may be an outline of the face or an outline of one of the facial features of the user, not to limit the scope herein. In one embodiment, for example, the video frame may be processed by a Laplace image detection method. The Laplace image detection method is an isotropic image detection method which means the degree of edge enhancement is unrelated to directions. The example below is a Laplace edge detection method using a three-multiply-three matrix.

$${H}_{North} = [ \begin{matrix}1 & 1 & 1 \\ 1 & - 2 & 1 \\ - 1 & - 1 & - 1\end{matrix} ]$$

$${H}_{EastNorth} = [ \begin{matrix}1 & 1 & 1 \\ - 1 & - 2 & 1 \\ - 1 & - 1 & 1\end{matrix} ]$$

$${H}_{East} = [ \begin{matrix}- 1 & 1 & 1 \\ - 1 & - 2 & 1 \\ - 1 & - 1 & 1\end{matrix} ]$$

$${H}_{EastSouth} = [ \begin{matrix}- 1 & 1 & 1 \\ - 1 & - 2 & 1 \\ - 1 & 1 & - 1\end{matrix} ]$$

$${H}_{South} = [ \begin{matrix}- 1 & - 1 & - 1 \\ 1 & - 2 & 1 \\ 1 & 1 & 1\end{matrix} ]$$

$${H}_{WestSouth} = [ \begin{matrix}1 & - 1 & - 1 \\ 1 & - 2 & - 1 \\ 1 & - 1 & 1\end{matrix} ]$$

$${H}_{West} = [ \begin{matrix}1 & 1 & - 1 \\ 1 & - 2 & - 1 \\ 1 & 1 & 1\end{matrix} ]$$

$${H}_{WestNorth} = [ \begin{matrix}1 & 1 & 1 \\ 1 & - 2 & 1 \\ - 1 & - 1 & - 1\end{matrix} ]$$

As shown in step 320, the facial features of the face of the user are extracted from the face area according to the image edge. For example, a curve fitting method calculates a plurality of curves approximating to the image edge. Then, the facial features of the face of the user are extracted from the face area according to the relevance between the curves, and the positions of the facial features of the face of the user are determined according to the curves. In detail, after a plurality of curves approximating to the image edge are obtained, it is still not known what facial features of the user each curve represents. In order to determine the facial features of the user, we need to know the size and appearance of and relative positions or relations between the curves. For example, the positions of two eyes are symmetric, and their distances to the nose are almost the same. After the steps described above, we may extract the facial features of the face of the user from the face area like the eyes and the nose from the video frame and may get to know their positions.

In the present embodiment, a facial feature database containing statistics of facial-feature data is provided. The facial-feature data are obtained by the following steps. First, a plurality of facial images are collected in any way as population. Then, horizontal and perpendicular distance data between the facial features of every facial image is estimated. After extracting the facial features of the user and determining their positions, in step 330, the facial feature database are referred to for the facial features of the user to estimate a tilt angle between a plane corresponding to the face of the user and a focusing direction of the camera lens towards the face on capturing the video frame. The present embodiment uses a plane formed by two mutually perpendicular lines, wherein the two lines are the ground line and the line crossing the nose peak of the user. According to the facial features of the user extracted and the facial-feature data contained by the facial feature database, we may know the estimated tilt angle formed between a plane corresponding to the face of the user and a focusing direction of the camera lens towards the face on capturing the video frame through geometric relevance between the facial features, wherein the plane may overlap the nose of the user and be perpendicular to the ground.

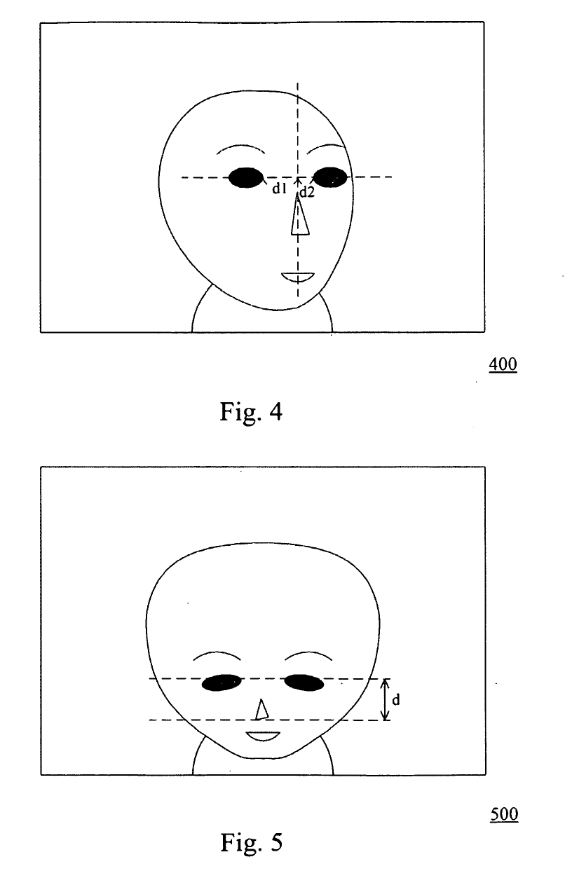

For example, FIG. 4 illustrates the video frame before adjustment according to one embodiment of the present invention. According to the positions of the eyes and the nose gained in step 320 shown in the video frame 400 of FIG. 4, the horizontal distances d1 and d2 from the eyes to the nose of the user are calculated in step 330. Then, the horizontal distances d1 and d2 are compared with the facial-feature data contained by the facial feature database to estimate a corresponding tilt angle.

FIG. 5 illustrates a video frame of another embodiment before adjustment, the perpendicular distance d between the eyes and the nose is calculated according to the positions of the eyes and the nose. Then, the perpendicular distance d is compared with the facial-feature data contained by the facial feature database to estimate the tilt angle formed by the camera lens and the nose peak of the user.

It is worth noting that although the positions of the facial features of the user are differ from different people and there is no absolute standard in the distances between the facial features of the user, the tile angle may be calculated by comparing with the statistics of facial-feature data contained in the facial feature database.

Finally, as shown in step 340 of FIG. 3, relative proportion between image parts in the face area is adjusted according to the estimated tilt angle. In one embodiment, the appearance of the face area is scaled linearly according to the estimated tile angle to arrive at a normal ratio in appearance of the face area to the video frame, wherein the normal ratio corresponds to an event that the tilt angle is substantially 90 degrees. Supposed that (u,v) is a coordinate of a pixel in the face area of the user, in order to easily record the movements to translate, scale and rotate in the matrix, we assume the value of homogeneous coordinate (w,w′) is (1,1). After adjustment, the coordinate of the pixel may be calculated by the equation below:

$$[ x , y , 1 ] = [ u , v , 1 ] * [ \begin{matrix}{S}_{u} & 0 & 0 \\ 0 & {S}_{v} & 0 \\ 0 & 0 & 1\end{matrix} ]$$

Sᵤ and Sᵥ represent the ratio for adjusting in perpendicular and horizontal direction, wherein the ratio relates to the tile angle. When Sᵤ or Sᵥ is greater than 1, it represents to magnify the video frame, whereas Sᵤ or Sᵥ is less than 1, it represents to minify the video frame.

In another embodiment, colors of a plurality of adjacent pixels to each pixel of the face area of the user are acquired. A corrective color for said each pixel of the face area of the user is calculated according to the colors of the adjacent pixels by a two-dimension linear interpolation method. To continue with the embodiment mentioned above, the corrective color P of pixel (u,v) is shown as below:

P=n*b*Pa+n*(1−b)*Pb+(1−n)*b*Pc+(1−n)*(1−b)*Pd

Supposed the origin of the video frame locates on lower left, we may calculate from the lower part of the video frame, and n is the difference between v and the Y-axis coordinate adjacent to v; calculate from the left part of the video frame, and b is the difference between u and the X-axis coordinate adjacent to u. The adjacent pixels are pixels adjacent to the pixel, such as the upper left pixel, the lower left pixel, the upper right pixel and the lower right pixel. Pa, Pb, Pc and Pd represent the colors of the adjacent pixels respectively. From the two-dimension linear interpolation method mentioned above, we can adjust the face area in the video frame according to the colors of the adjacent pixels to each pixel.

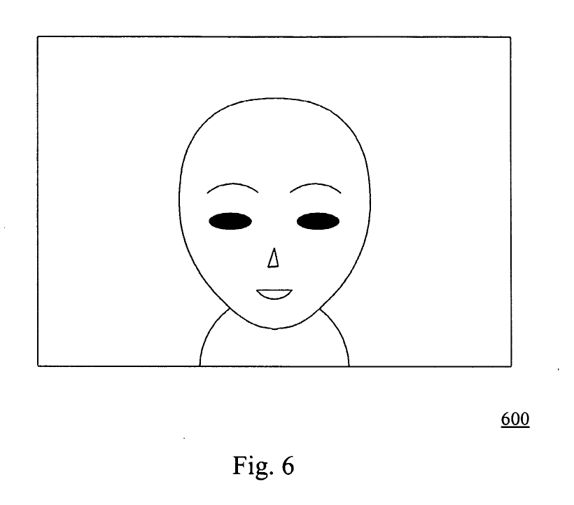

By the steps shown in FIG. 3, we may adjust the face area in the video frame so that the video frame although taken with the tilt angle displays a video image effect of the face area in it as seen by a person from a position in front of and substantially level with the face (as shown in the video frame 600 of FIG. 6). In that case, we can achieve the effect that the video frame of the user's face area captured by the camera lens displays a video image effect of the face area in it as seen by a person from a position in front of and substantially level with the face.

In another embodiment of the present invention, after the video frame captured by the camera lens, an offset distance between the face area and a center of the video frame is detected, and then the position of the face area is changed to be at the center of the video frame according to the offset distance. Accordingly, the called party can receive the video image of the user locates in the center of the video frame to avoid being unable to see the video image of the caller because of the position shift.

To conclude, in the embodiment of the present invention for adjusting the video frame, we may extract the facial features of the user and compare with the facial feature database according to facial features of the user. The tilt angle between a plane corresponding to the face of the user and a focusing direction of the camera lens towards the face on capturing the video frame is calculated, and then relative proportion between image parts in the face area is adjusted. Accordingly the disproportionate displayed effect of the face area due to the tilted face image captured can be corrected, and then we can ensure that the called party receives the video frame displaying a video image effect of the face area in it as seen by a person from a position in front of and substantially level with the face and having no tilted image of the face area, and thus increase the quality of video communication.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for adjusting a face area of a user in a video frame captured by a camera lens, the method comprising:
detecting an edge of an image in the video frame, the image containing a face area representing a face of a user;
extracting a plurality of facial features of the face of the user from the face area according to the image edge;
referring to a facial feature database for the facial features of the user, to estimate a tilt angle between a plane corresponding to the face of the user and a focusing direction of the camera lens towards the face on capturing the video frame, wherein the facial feature database contains statistics of facial-feature data; and
adjusting relative proportion between image parts in the face area according to the estimated tilt angle.

2. The method of claim 1, wherein detecting the image edge is by an edge detection method.

3. The method of claim 1, wherein the image edge comprises an outline of the face or an outline of one of the facial features of the user.

4. The method of claim 1, wherein extracting the facial features of the user according to the image edge comprises:
calculating a plurality of curves approximating to the image edge by a curve fitting method; and
extracting the facial features of the user according to the relevance between the curves.

5. The method of claim 4, wherein extracting the facial features of the user according to the relevance between the curves comprises:
determining the positions of the facial features of the user according to the curves.

6. The method of claim 1, wherein the facial features of the user comprise eyes and a nose of the user.

7. The method of claim 6, wherein referring to a facial feature database for the facial features of the user comprises:
calculating a horizontal distance between the eyes and the nose of the user; and
comparing the horizontal distance and the facial-feature data contained by the facial feature database to estimate the tilt angle.

8. The method of claim 6, wherein referring to a facial feature database for the facial features of the user comprises:
calculating a perpendicular distance between the eyes and the nose of the user; and
comparing the perpendicular distance and the facial-feature data contained by the facial feature database to estimate the tilt angle.

9. The method of claim 1, wherein adjusting relative proportion between image parts in the face area according to the estimated tilt angle comprises:
scaling an appearance of the face area linearly according to the estimated tilt angle to arrive at a normal ratio in appearance of the face area to the video frame, wherein the normal ratio corresponds to an event that the tilt angle is substantially 90 degrees.

10. The method of claim 1, wherein adjusting relative proportion between image parts in the face area according to the estimated tilt angle comprises:
acquiring colors of a plurality of adjacent pixels to each pixel of the face area of the user;
calculating a corrective color for said each pixel of the face area of the user according to the colors of the adjacent pixels by a two-dimension linear interpolation method; and
updating an appearance of the face area with the corrective color for said each pixel of the face area of the user.

11. The method of claim 10, wherein the adjacent pixels comprise an upper left pixel, a lower left pixel, an upper right pixel and a lower right pixel adjacent to said each pixel of the face area of the user.

12. The method of claim 1, further comprising:
detecting an offset distance between the face area and a center of the video frame; and
changing the position of the face area to be at the center of the video frame according to the offset distance.
